(19) United States
(12) Patent Application Publication
(10) Pub. No.: US 2002/0116708 A1
(43) Pub. Date: Aug. 22, 2002

(54) User interface for a streaming media client

(76) Inventors: Richard M. Morris, Woodinville, WA (US); Todd Greenwalt, Kirkland, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/956,492

(22) Filed: Sep. 18, 2001

Related U.S. Application Data
(60) Provisional application No. 60/254,708, filed on Dec. 11, 2000.

(51) Int. Cl. G06F 3/00; H04N 5/445; G06F 13/00; G09G 5/00; H04N 7/173

(52) U.S. Cl. 725/37; 345/760; 345/749; 345/700; 725/110; 725/112

(57) ABSTRACT

A user interface for a streaming media client includes web browser-type controls provided by a web page and hosted by a top-level web browser application. The user interface includes other controls for controlling the access, retrieval, and delivery of digital media to a client system. The browser-type controls are generated by executable client-side scripts that are called through the top-level web page. The top-level web page is provided by a media gateway, through which communication with a user, and user commands, takes place.

### STATEMENT OF RELATED APPLICATIONS

This application claims the benefit of U.S. Provisional Application No. ______, filed Dec. 10, 2000 and entitled “TECHNIQUE FOR CONTROLLING STREAMING MEDIA CONTENT FROM A VARIETY OF SERVERS AND SOURCES,” which is incorporated herein in its entirety. This application also relates to U.S. patent application Ser. No. ______, filed ______ and entitled “STREAMING MEDIA CLIENT SYSTEM AND METHOD,” which is incorporated by reference herein for all purposes.

### BACKGROUND OF THE INVENTION

Media systems include cable or satellite video delivery networks, in which users can access and receive a copy of a video file that is stored at a node in the network. One such video delivery system is known as video-on-demand (VOD), where users can order a video file through their cable or satellite receiver systems.

Almost all media delivery systems use some type of “set-top box” (STB), which refers to a receiver device that is usually placed on top of a television set for decoding and descrambling video or audio signals that are received via cable or satellite. Traditional STBs run embedded operating systems that have limited functionality, support, and life cycles. Further, these embedded operating systems are usually proprietary to the manufacturer, which limits their scalability and adaptability to new features and functions.

However, the demand for real-time, on-demand streaming media is exploding. In a so-called “open system” such as the Internet or World Wide Web (the “Web”), users can download video or audio files in pieces, which are reassembled and played at the user's computer. Video and audio downloads, however, can sometimes be extremely slow, and do not provide real-time access to streaming media. Further, at real-time play speeds, the quality of the media is usually degraded.

### BRIEF DESCRIPTION OF THE DRAWING

FIG. 1 is a simplified block diagram of a digital media client system according to an embodiment of the invention.

FIG. 2 is a functional block diagram of a digital media client system according to an embodiment of the invention.

FIG. 3 illustrates a overlay mixer and filter for generating a user interface according to the invention.

### DETAILED DESCRIPTION OF THE PREFERRED EMBODIMENTS

This invention relates to a user interface for a multimedia client that receives and processes real-time, high-quality multi-media. An embodiment of the invention includes a computer-generated graphical display that is rendered as a user interface for controlling the processing of digital media, such as video and/or audio. The user interface is superimposed on the processed digital media. According to a specific embodiment, a web page provides browser-type controls rendered as graphics, which are blended with processed digital media into a single picture, and displayed by a web browser that hosts the web page.

According to the invention, the user interface works as a web page container when displayed on a television, while hiding all of the personal computer-type and web browser-type interfaces. The web browser controls are encapsulated in a specialized top-level web page window displayed on a television. In addition to supporting web browser-based control of digital media processing and display, the user interface also provides runtime network monitoring, inter-process communications, and child-thread management.

The digital media that is processed by the media client is preferably audio and video, but can be any type of digitized content. For example, the digital media can be streaming video that is accessed and downloaded from a remote source across a network. The network can be a wide area network (WAN) such as the Internet, a local area network (LAN) such as a private network or Intranet, or even two or more devices which communicate over a shared connection. The remote source can be a network server or video server that stores the digital media or a copy of the digital media. Further, the digital media can be stored, accessed, and downloaded locally, such as from a digital video disk, compact audio disc, floppy disk, digital or analog video tape, or fixed or removable hard disk storage drive, etc.

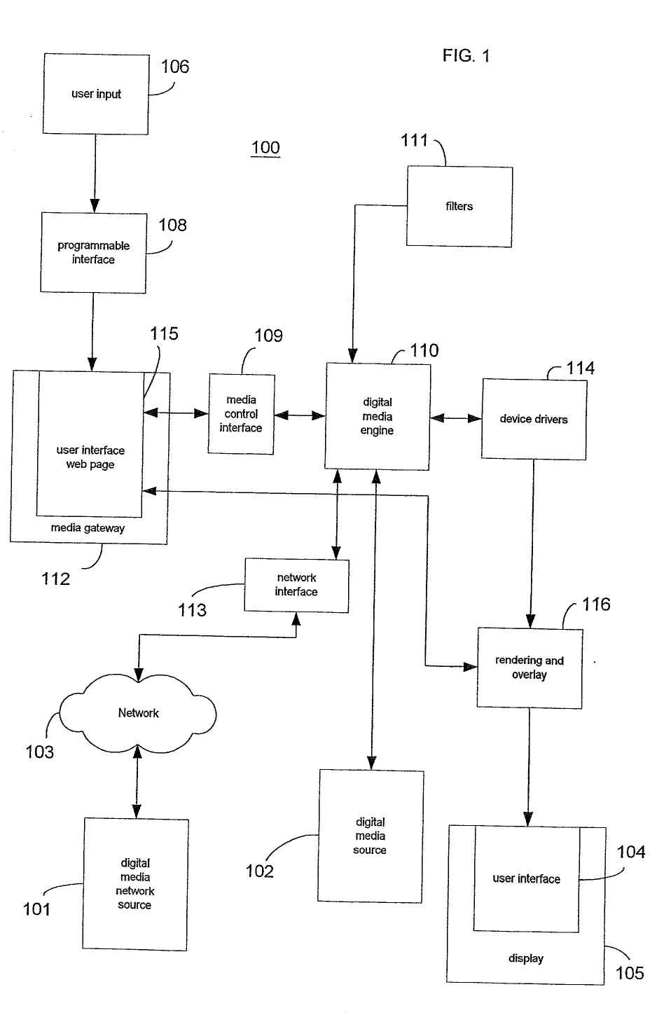

An exemplary mechanism by which the user interface is generated and used is described with reference to FIG. 1, which shows a simplified block diagram of a multimedia client system 100. The multimedia client system 100 receives a number of types of digital media from various digital media sources 101, 102. One such digital media source can be a video server 102, such as a VOD server. The video server 102 stores a copy of a digital file, such as a video or audio file, in an accessible memory location associated with the video server 102. The digital media is accessed from the video server 102, typically in accordance with a particular protocol, after which it transmits the selected digital media to the system 100.

The communication medium from the video server 102 to the rest of the system 100 can be a direct link. For instance, the video server 102 may comprise a digital media storage device, such as a digital video disk player, and the hardware and software employed to allow the video server 102 to be accessed and send the requested media. The video server 102 may also be remotely located, accessible via a network.

Where a broader network is used, the digital media source can be a network server 101. A network server 101 is configured to stream and/or download digital media over a network 103 according to a specific network protocol. Streaming media over the Internet, for example, is typically done in accordance with the Internet Protocol (IP) for packet-based transmission. The network server 101 is connected through the network 103 via a network interface 113. Other types of digital media and digital media sources may be used. The digital media sources described herein are for example only.

The digital media is processed by the system 100 and delivered to a display 105. A user interface 104 is rendered within the display 105. Suitable devices for the display include, without limitation, video graphic displays such as a television, computer monitor, flat-panel display screen, liquid crystal display (LCD), or any other device that is adapted to visually render graphics and video.

The system 100 further includes a user input 106 for receiving input signals from a user. The user input signals represent commands, requests, instructions, etc. The user input 106 includes one or more user input devices, including, without limitation, a keyboard, keypad, mouse, rollerball, handheld remote keyboard or keypad, lightwand, wireless device, or optical device, etc. The user input 106 may also include a card swipe reader for receiving credit card and/or financial information. The user input 106 is preferably used in conjunction with the user interface 104, and in one embodiment can include being rendered as a part of the user interface 104. For instance, user-controllable function buttons can be rendered as graphics or links within the user interface 104. The functions provided by the user interface 104 and controlled by the user input 106 are preferably based on web-browser controls. A list of such controls is provided below.

Signals from the user input 106 are provided to a programmable interface 108, which can include a programmable interface control (PIC) card and associated PIC services software. The programmable interface 108 is responsible for communicating with the input/output hardware sub-systems, including peripheral user input devices that comprise the user input 106.

The system 100 also includes a media gateway 112, through which user control data is communicated. In one embodiment, the media gateway 112 includes a software program that provides a communication interface between client-side computer programs and computer programs residing on a network. The media gateway 112 includes a web browser application. The browser application is preferably one of several commercially-available browsers that supports a wide range of multimedia capabilities, such as Internet Explorer™ from Microsoft Corporation, or Netscape Navigator™ from Netscape, Inc.

The media gateway browser hosts a user interface web page 115. The user interface web page 115 renders mark-up language-based information, such as hypertext markup language (HTML), dynamic HTML (DHTML), or extensible markup language (XML), which is used for interactive communication between the user and the media source via the programmable interface 108. The user interface web page 115 provides the user interface 104 as a set of browser-based control functions, and is hosted by the web browser provided by the media gateway, thereby providing browser-in-browser functionality.

As stated above, the user interface web page 115 provides a graphical user interface with user controls rendered with HTML, DHTML, or XML tags, and which are displayed on the user interface 104. The user interface web page 115 can be generated locally by the media gateway 112, or downloaded from a remote server, and then rendered by the media gateway 112. The user interface web page 115 provides controls for directing the operation of any of the digital media sources through a media control interface 109.

The media control interface 109 preferably includes a computer program configured to communicate control signals between the user interface web page 115 and the digital media engine. The media control interface 109 receives user input based on the user interface controls, and sends control signals to a digital media engine 110 based on that user input. The digital media engine 110 executes the user input to access, receive and process the digital media, and renders the processed media on the user interface 104. When the user interface web page 115 is generated by the media gateway, the user interface can persist even in the event of a terminated network connection.

The media gateway 112 can include control objects, such as ActiveX control XKeys or Java applets for example, that are provided to the user interface web page 115 and executed to perform one or more functions. One such function is to trap keystrokes and mouse movements passed by the programmable interface 108. These, in turn, are processed by the same or other control objects for controlling the digital media engine 110. The media gateway 112 can also include several program tools that make the system 100 scalable for receiving and processing other types of user commands.

The digital media engine 110 includes a number of services that enable playback of audio and video, or other content, to the user interface 104, and which control and instantiate a number of different types of filter graphs provided by filter module 111. A filter graph is a self-contained software program configured for performing one or more digital media processing functions, such as parsing content from the digital media for further processing, for example. Specific filter graphs are employed, individually or as a group, depending on the type of digital media that is to be processed. The digital media engine 110 also includes other processing modules, including, but not limited to, cipher engines such as encoders, decoders, demodulators, or compression and/or decompression engines. Each of these processing modules can be implemented in hardware, firmware, or in software. FIG. 1 merely illustrates one example of a digital media retrieval system in accordance with the invention.

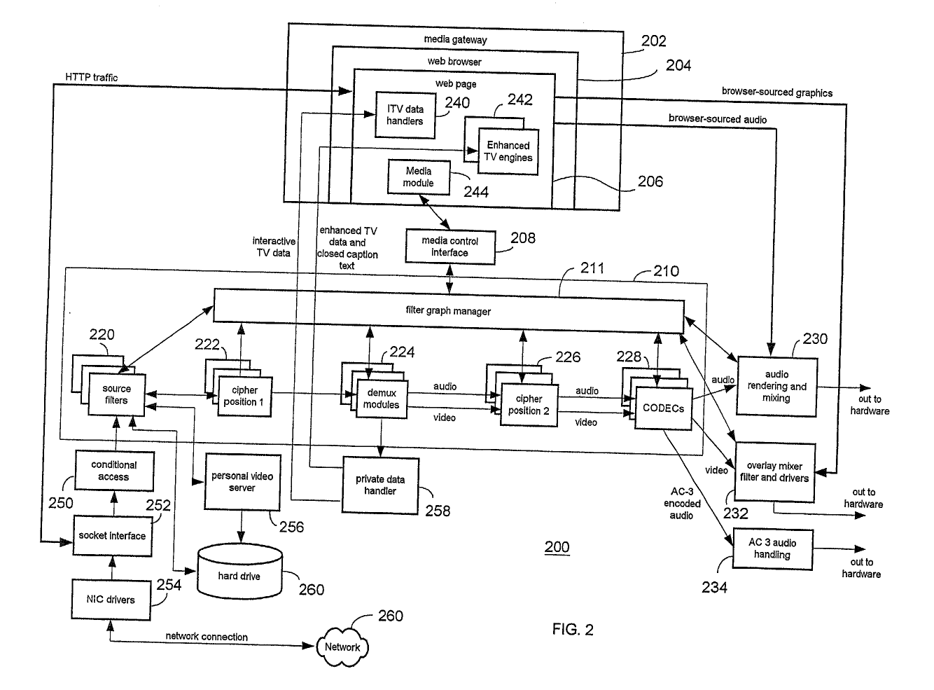

FIG. 2 shows a functional block diagram of a multimedia client system 200 according to another embodiment. Each of the blocks in the system 200 can be implemented in hardware, firmware, or as software. For example, digital signal processing (DSP) can be accomplished using an application specific integrated circuit (ASIC) that is suited for a particular DSP task. Alternatively, a general purpose computer processor, running at high processor clock speeds, can be programmed to accomplish certain DSP functions. A hardware implementation of the system 200 can have any type of suitable configuration, and accordingly this invention does rely on any specific hardware. Likewise, a software implementation can be hosted on any operating system, such as Windows or Linux, for example.

The system 200 includes a media gateway 202, a top-level application program that generates a window for displaying control graphics and video. The media gateway 202 includes a web browser application program that contains an instance of a web browser 204 and associated controls, such as Microsoft's Internet Explorer™ and its IE WebBrowser controls, respectively. The web browser 204 hosts a web page 206 that provides connectivity to the World Wide Web (hereinafter, the “Web”) via one or more user-selectable graphical links. The Web is a network of HTTP-compliant data locations distributed among the Internet, and at least one of those data locations in the Web is a digital media source from which selected digital media is downloaded for display. The user-selectable graphical links represent browser-type user controls. Accordingly, the user interface provides a browser-within-browser configuration.

The web page 206 includes one or more control programs 240, 242, and 244, each of which is preferably a self-contained client-side script. The control programs 240, 242, and 244 are independently configured for, among other functions, generating graphical or text-based user controls in the user interface, for generating a display area in the user interface as directed by the user controls, or for displaying the processed streaming media. The control programs 240, 242, and 244 can be implemented as ActiveX controls, as Java applets, or as any other self-contained and/or self-executing application, or portion thereof, operable within a media gateway 202 container environment and controllable through the web page 206.

Internet content is displayed within a frame in the web page 206. In an embodiment, the web page 206 generates an instance of an ActiveX control. ActiveX refers to a set of object-oriented programming technologies and tools provided by Microsoft Corporation of Redmond, Wash. The core part of the ActiveX technology is the Component Object Model (COM). A program run in accordance with the ActiveX environment is known as a “component,” a self-sufficient program that can be run anywhere in the network, as long as the program is supported. This component is commonly known as an “ActiveX control.” Thus, an ActiveX control is a component program object that can be re-used by many application programs within a computer or among computers in a network, regardless of the programming language with which it was created. An ActiveX control runs in what is known as a container, which is an application program utilizing the COM program interfaces.

One advantage of using a component is that it can be re-used by many applications, which are known as “component containers.” Another advantage is that an ActiveX control can be created using one of several well-known languages or development tools, including C++, Visual Basic, or PowerBuilder, or with scripting tools such as VBScript. ActiveX controls can be downloaded as small executable programs, or as self-executable code for for Web pages animation for example. Similar to ActiveX controls, and suitable for the client-side scripts, are applets. An applet is typically a self-contained, self-executing computer program written in Java™, a web-based, object-oriented programming language promulgated by SUN Microsystems Corp. of Sunnyvale Calif.

The control programs 240, 242, and 244 can be stored and accessed locally at the client system 200, or downloaded from the network 260. Downloading is typically done by encapsulating a control program in one or more markup language-based files. The control programs can also be used for any commonly-needed task by an application program running in one of several operating system environments. Windows, Linux and Macintosh are examples of operating system environments.

The control programs provide functionality to enhance the user's experience. The number and type of control programs is not limited to those described herein. For instance, one control programs can include interactive television (ITV) data handlers 240 for interactive communication with the digital media, enhanced television engines 242 for providing features such as recording and playback, and a media module 244, for media processing. Other capabilities are possible through the use of additional control programs.

The media module 244 provides access from the web page 206 to a digital media engine 210 for controlling the playback of digital video and audio, launching multicast, broadcast TV, and/or other streaming video services supported by the client system 200. For example, video on demand (VoD) functions can be controlled from a single DHTML web page 206 that contains the media module 244 and the client-side script with which it interfaces. Streamed and decoded video is viewed through the web page 206, which is invisible to the user even though the user interacts with the system 200 through the web page.

The media module 244 communicates with a media player 208 to control the digital media engine 210. The media player 208 is a hardware-independent application program that interprets commands from the media module 244 to control a filter graph manager 211. The filter graph manager 211 controls how a filter graph is assembled from source filters 220, and how data is moved through the assembled filter graph. The media player 208 directs the filter graph manager 211 to construct an appropriate filter graph for a particular media format specified by user input through the media module 244. The media player 208 also provides an interface to the filter graph manager 211 through which to add proprietary filters, either to the source filters 220 or an assembled filter graph.

Source filters 220 are registered for preferential or default loading, and to present the correct filter type for compatibility with the media type. Blocks 222, 224, 226, and 228 in FIG. 2 represent filters and/or processing modules which the filter graph manager 211 controls, or through which the filter graph manager 211 monitors data. Cipher position 1 modules 222 perform a block cipher routine on encrypted multiplexed digital media. Demultiplexing modules 224 demultiplexes the transport stream of a multiplexed digital media stream. Cipher position 2 modules perform a second block cipher routine on encrypted, demultiplexed digital media.

Compression/decompression (CODEC) modules 228 decompress a compressed digital media stream. The CODEC modules 228 are scalable to include various types of CODEC algorithms for any media type, and can be implemented specifically in hardware or software. For example, MPEG-1 and MPEG-2 decompression algorithms are preferably performed with specific dedicated CODEC hardware chips. However, an MPEG-4 software module can be activated to decompress a compressed MPEG-4 stream. Other CODEC algorithms performed by the CODEC modules 228 can include wavelet-based compression, True Motion™ VP3 provided by On2.com, Inc., and compression algorithm provided by TeraNex, Inc. Other proprietary or open CODECs can be employed. The filter graph manager 211 directs which CODEC module 228 is appropriate for a particular digital media type.

In a specific exemplary embodiment, the web page 206 provides a list of video titles. The user can click on one or more of the video titles, which selection is interpreted by the media module 244. The media module 244 will then pass the selected video title(s) to the source, initialize the source, activate any special playback parameters including the appropriate filter graph, set the video display parameters, and start the playback of the selected video. The system 200 provides a digital video SVGA graphics overlay on top of the playing, decoded MPEG video stream. This digital overlay is then reformatted to NTSC or PAL, and then output to the appropriate hardware. For example, the digital overlay can be rendered in 24-bit, 640×480 pixel resolution for NTSC, and 800×600 for PAL.

The control programs 240, 242, and 244 provided by the user interface web page 206 can be configured to operate on data provided by the private data portion of a digital media packet cell. For instance, the MPEG-2 transport cell includes a cell header, a video section including a video section header, an audio section including an audio section header, and a private data section including a private data section header. The video section contains encoded video content, encoded according to MPEG-1 or -2 encoding standards. The video content is arranged in packets, called the “payload.” The audio section includes MPEG-3 encoded audio packets. The private data section includes packets of data having no use restrictions. Accordingly, the private data section can include, by way of example and not limitation, closed-captioning data, teletext data, or even web page data for generating an XML-coded web page for the web page 206.

The user interface of this invention adds robust web browsing functionality to the media gateway 202 web browser 204. The user interface web page 206 calls methods and handles events that can navigate to any other web page through a link. The combination of the media gateway 202 and user interface forms a “browser-in-browser” architecture. The browser-in-browser architecture provides Internet access on a TV platform. The web page 206 provides a graphical user interface (GUI) that is displayed within the media gateway application frame. Internet content is displayed within a frame in the web page 206. The control programs 240, 242 and 244 monitor network integrity during operation. If network integrity is compromised, the user interface 206 will redirect user control to a default or customized error handling page.

A frameset and frames collection, which provides access to the individual frames, is preferably written in HTML or DHTML code. Each frame is an instance of the media gateway browser window, so the object model for windows is also applicable to each frame. Techniques for manipulating windows can also be used for manipulating the frames.

According to a specific exemplary embodiment, scripting languages and visual tools can use an abstracted interface to the ActiveX controls. This interface is called the IDispatch interface and simplifies calling methods and getting and setting properties. To access the user interface methods, events, or properties from a web page, the user interface must be instantiated and visible on the web page.

The system 200 further includes an audio rendering and mixing block 230 for mixing browser or web-based audio from the web page 206 with processed digital media audio from the digital media engine 210. An overlay mixer filter 232 performs the overlay of web browser-based, user control graphics onto the decoded video stream from the CODEC modules 228, and provides the composite picture for display. In the absence of a video stream, the web browser graphics can be displayed independently, or as a standard web browser graphical interface which hosts a web page.

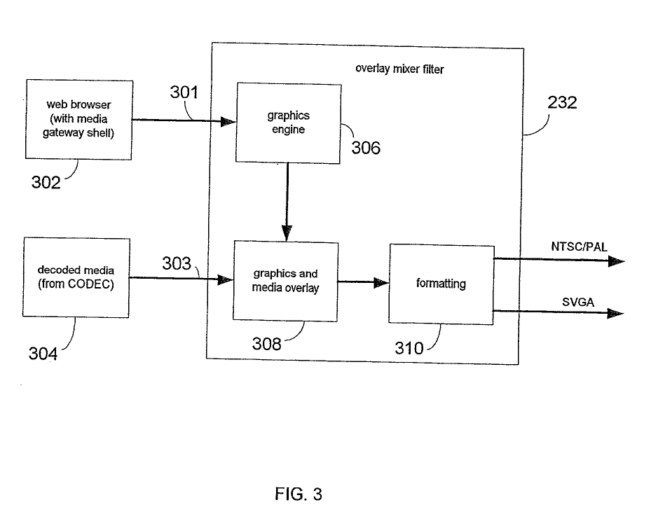

FIG. 3 illustrates the overlay mixer filter 232, including a first input 301 for receiving web browser graphics 302 within the media gateway shell, and a second input 303 for receiving decoded media 304 from the CODEC modules 228. The web browser graphics are generated from a user interface web page, and rendered by a graphics engine 306, preferably in accordance with a markup language. The rendered user interface graphics from the graphics engine 306 are provided to a graphics and media overlay module 308, for being superimposed on or overlaid with the decoded media 304. The composite video signal from the overlay module 308 is then provided to a formatter 310, for formatting to either NTSC or PAL for television display, and to SVGA for computer monitor display.

Referring back to FIG. 2, the system further includes connectivity to a network 260. The connection is made to the system through a network interface card (NIC) and NIC drivers 254 to a standard Winsock interface 252, through which two-way hypertext traffic is transmitted. A conditional access module 250 is provides secure access to the system 200 and source filters 220 therein. The conditional access module 250 can be a software program that verifies a user based on conditional data including a user name and/or password. The network connectivity is used for receiving digital media from the network 260, such as the Web or local area network for example.

For local access and downloading of digital media, a personal video server 256 can be connected with the system. The personal video server 256 stores one or more video files, and can be implemented on the same platform as the rest of the system, or on a separate platform connected via a data bus. A hard drive 260 may also be provided for long term storage of client-side scripts, source filters, digital media files, or executable code for use by the system 200.

The system further can include a private data handler 258. The MPEG-2 Transport Cell includes a Private Data section that can contain data in addition to the encoded video and audio data. The MPEG-2 standards do not restrict the nature of this data and the Private Data section of the MPEG-2 Transport Cell is used in a number of different ways. For example, closed captioning data is typically carried in the Private Data section. Other types of data can also be used to create “enhanced TV” graphics that are rendered and overlain upon the video images. For this additional data to be interpreted and rendered as intended, it must be parsed out of the Private Data section, identified, and handed off to the appropriate software module for rendering.

The MPEG-2 Transport Demux Module 224 parses the data out of the private data section of the MPEG-2 Transport Cell and passes this data to the private data handler 258 software module. The private data handler 258 attempts to identify the nature of this data by a sorting process. When the data is identified as a specific type, the private data handler 258 then passes the data to the appropriate software module for rendering.

The additional data parsed from the Private Data section will fall into one of 3 broad categories: Closed captioning data, Enhanced TV Graphics data, and Interactive TV application data. Closed captioning data will be passed to an Enhanced TV Engine 242 that can convert the data into text graphics. Enhanced TV Graphics data will be passed to an Enhanced TV Engine 242 that can convert the data into graphics. Both Closed captioning and Enhanced TV text and graphics will be rendered by the web browser and overlain onto the decoded video as described in FIG. 1. Interactive TV application data will be passed to an Interactive TV Data Handler 240 that can interact with other parts of the streaming media client system software.

An AC 3 audio handler 234 is provided for handling AC-3 encoded digital audio. AC-3 encoded digital audio can be handled three different ways: it can be passed in digital form to an external AC-3 decoding device over an S/PDIF connector, it can be decoded by hardware and passed in analog form to speakers over up to 5 RCA connectors, or it can be decoded by software and passed in analog form to speakers over up to 5 RCA connectors. The AC-3 audio handler 234 performs one of these three functions, depending upon the design of the streaming media client.

The user interface is provided by a web page hosted by the media gateway browser. New “daughter” instances of the media gateway browser window can be created using a window object or control program, thus creating new window objects. In addition, the window object provides methods that allow for the display of a variety of dialog boxes and Java or HTML-based “help” windows. Custom modal dialog boxes and help files whose contents are located in another Java or HTML document can also be created.

The toolbar and status bar of the typical web browser are preferably not displayed in the daughter window. This applies to all multiple instances of the browser. The cursor, mouse, pointing device, and keyboard keys will retain all the expected functionality in the multiple windows. The daughter window can be resizable. The daughter window is preferably always rendered on top of, and not hidden by, the main window. Loss of focus of the processed media can be indicated to the user by “graying” the title bar.

The user interface provides the ability to customize the streaming media client using Web technology so that many functions can be provided to the end users, such as controlling the playback of video and audio, VoD, launching multicast and broadcast media streams, and other functions. The user interface of the invention supports many web browser-based control functions. These functions enable methods and other functions for navigation and control of the digital media display experience. The web-browser-based control functions provided by the user interface include, but are not limited to, the following functions:

Go Back

Navigates the browser back one entry, or web page, in the history to a previous page. If the pointer is at the beginning of the web browser buffer, this command will not perform any action.

Go Forward

Navigates the browser forward one entry in the history, or one page. If the pointer is at the end of the web browser buffer, this command will not perform any action.

Home

Navigates the user interface to the homepage recorded in the registry. The location of the home page can be changed.

Navigate Browser

Navigates the user interface to the specified URL.

Stop

Stops the user interface from navigating to the next URL. This command will also stop animations on the loaded page.

Refresh

Refreshes the current page, or reloads the page from cache if available.

Complete Refresh

Complete refresh reloads a page from the server.

Zoom

Zooms in on the currently-displayed web page. This toggles the Zoom level to the next higher level. In one embodiment, the user interface supports five browser zoom levels. The five browser zoom levels are Smallest, Small, Medium, Larger, and Largest. The zoom level can also be set directly using a Zoom factor property.

Remove Cookies

Causes the system to loose its cookies.

Open History

Initializes the history array and fills the HistoryTitle and HistoryURL properties of the user interface with the most recent pages from the array. The properties can then be read.

Get Next History Entry

Command fills the title and URL properties of the user interface with the most recent Title and URL in the History. This command accesses entries prior to the last Title and URL in the History call and reads the properties again. The end of the History array is reached when the properties return a “Null”.

Clear History

Clears the History Array.

Scroll Page

Scrolls the current page up/down or left/right. X and Y parameters specify the distance that the will scroll. A negative X value will scroll to the left and a positive will scroll to the right. A negative Y value will scroll down while a positive will scroll up.

Navigate to File

Used for loading a local page into a WebCtrl window.

Remove All Popups

Allows for the closing all of popup windows.

WebCtrl Browser Events

WebCtrl Browser events are backward compatible in function with Inet Control events.

Before Navigate

Fired before the user interface starts to navigate or download a new page. Passes the URL that the browser will navigate to, and calls an event Handler on the new host page.

Navigation Complete

Executed when the User interface Control completes its navigation or download. Passes the URL of the page that has been navigated to, and calls the event Handler on the host page.

Update Back Button

Executed when the user interface needs to enable or disable the back button. Calls event handler on host page and passes a Boolean to indicate the enable status of the Button. TRUE will enable the button, and FALSE will disable the button.

UpdateForwardButton

Executed when the user interface needs to enable or disable the forward button. Calls event handler on host and passes a Boolean to indicate the enable status of the Button. TRUE will enable the button, and FALSE will disable the button.

Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. A method for controlling delivery of streaming video, comprising:
superimposing a web browser on a video picture displayed from a decoded video stream; and
forming a user interface within a web page hosted by the web browser.

2. The method of claim 1 further comprising generating browser controls in the web page to form the user interface.

3. The method of claim 2, wherein the browser controls include one or more hyperlinks.

4. The method of claim 3, wherein each of the one or more hyperlinks are configured to link to and activate a control program.

5. The method of claim 4, wherein the control program is an ActiveX control.

6. The method of claim 4, wherein the control program is a Java applet.

7. The method of claim 2, wherein the browser controls are represented as graphics.

8. A method for providing a user interface in a digital media content receiver system, comprising:
decoding a digital content stream to display the digital content; and
superimposing a web browser on the decoded digital content, the web browser hosting a web page that provides a user interface for controlling delivery of the digital content.

9. The method of claim 8, further comprising receiving user inputs via the user interface provided by the web page.

10. The method of claim 9, further comprising processing the user inputs to control the digital content stream.

11. A system for controlling delivery of streaming video, comprising:
a web browser superimposed on a video picture displayed from a decoded video stream; and
web page hosted by the web browser, the web page forming a user interface.

12. The system of claim 11, wherein the web page hosts a plurality of links representing user controls.

13. The system of claim 12, wherein the user controls are graphical objects.

14. The system of claim 13, wherein the graphical objects are provided by one or more client-side scripts, the scripts being executable by the web browser.

15. The system of claim 14, wherein the one or more client-side scripts are downloaded from a remote web site.

16. A user interface for controlling streaming media content from a variety of sources, comprising:
an HTML-rendering application for rendering a web browser, the web browser configuring a display region in a display for displaying digital media content; and
a web page generated by the web browser, the web page including web browser functions and being superimposed over the displayed digital media content to provide a user interface for controlling delivery of the digital media content.

17. A user interface for controlling streaming media content from a variety of sources, comprising:
a web page configured to display the streaming digital media content; and
a graphical user interface generated by the web page and superimposed over the displayed digital media content.

18. A method of forming a user interface for controlling the receipt of streaming media, comprising:
receiving a stream of digital video for display;
generating graphics representing web browser controls;
superimposing the graphics over the displayed digital video.
